(19) United States
(12) Patent Application Publication
(10) Pub. No.: US 2009/0004582 A1
(43) Pub. Date: Jan. 1, 2009

(54) Electrophotographic toner

(75) Inventor: Sang-woo Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 12/003,819

(22) Filed: Jan. 2, 2008

(30) Foreign Application Priority Data
Jun. 28, 2007 (KR) 10-2007-0064618

(51) Int. Cl. G03G 9/097; G03G 15/06; G03G 13/14

(52) U.S. Cl. 430/48; 430/108.6; 399/222

(57) ABSTRACT

An electrophotographic toner is provided including parent toner particles having a small average particle diameter and external additives applied to the surface of the parent toner particles. The external additives include: a large particulate silica; a small particulate silica; a conductive titanium oxide; strontium titanate; and an aluminum oxide. High-quality and high-speed imaging can be performed using the toner since the amount of toner charge can be stably maintained for both initial and long-term use.

### CROSS-REFERENCE TO RELATED PATENT APPLICATION

This application claims the benefit under 35 U.S.C. § 119(a) of Korean Patent Application No. 10-2007-0064618, filed on Jun. 28, 2007, in the Korean Intellectual Property Office, the disclosure of which is hereby incorporated herein in its entirety.

### BACKGROUND OF THE INVENTION

1. Field of the Invention

The present general inventive concept relates to a non-magnetic one-component toner for electrophotography. More particularly, the invention relates to a non-magnetic one-component toner for electrophotography which can form high resolution and high quality with a considerable level of uniform image density without contamination in background regions due to unregulated toner. An amount of small particulate toner charge and charge distribution can be stably maintained using the toner for initial and long-term use.

2. Description of the Related Art

Laser printers, facsimile machines and photocopiers are widely used as electrophotographic imaging apparatuses. In such apparatuses, a latent image is formed on the surface of a photoreceptor using a laser beam, toner is supplied to the latent image on the photoreceptor by an electric potential difference, and the supplied toner is transferred to a printing medium such as paper to form images.

FIG. 1 schematically shows a conventional electrophotographic imaging apparatus (non-contact developing type) which operates according to the following process. A photoreceptor 1 is charged by a charging apparatus 6, and a latent image is formed on the surface of the photoreceptor through light-exposure using a laser scanning unit (LSU) 9. A non-magnetic toner 4 is supplied to a developing roller 2 by a supply roller 3. The toner supplied to the developing roller 2 is smoothed to form a thin layer by a toner layer regulation apparatus 5 and high friction charged. The toner that passes the toner layer regulation apparatus 5 is developed on the latent image formed on the photoreceptor 1, and the developed toner is transferred to paper by a transferring roller (not shown) and fixed by a fixing apparatus (not shown). In addition, the toner 8 remaining on the photoreceptor 1 is cleaned by a cleaning blade 7.

Recently, as electrophotographic imaging apparatuses such as laser beam printers (LBPs) for electrophotography, multifunctional devices and color photocopier have been widely used, high quality images are required. For this, much research on toner having characteristics such as stable amount of toner charge and high developing efficiency without fog generation against environmental changes and variations according to a long-term use has been actively conducted.

In order to control stability of the amount of toner charge, prevention of fog, improvement of developing efficiency, various external additives such as silica, titanium oxide (TiO₂), aluminum oxide (Al₂O₃), strontium titanate (SrTiO₃), barium titanate (BaTiO₃), and calcium titanate (CaTiO₃) have been applied to the toner. However, improvement of image quality is limited. That is, charging properties of toner largely vary according to environmental changes such as low temperature and low humidity, and high temperature and high humidity. Although toner is uniformly charged and charge distribution is uniform at the initial operation of printing, the amount of toner charge largely decreases when the printing is continuously performed. In addition, image density decreases and fog and toner scatter result by reduction in the amount of toner charge and non-uniform charge distribution due to a long-term printing.

Thus, the types of the external additives added to improve image quality increase, and the amount of the external additives also increases. The external additives need to be stably maintained on the surface of toner during a long-term printing. However, the external additives are often buried in the toner particles or desorbed and separated from the toner particles, thereby contaminating a developing member and images. The external additives are easily desorbed and separated as the particle size of the external additives increases and cohesive force between the external additives increases. Recently, such desorption and separation become more serious due to increasing the number of types and amount of the external additives.

Characteristics such as high speed faster than 30 ppm with printer network, long life time suitable for color printing of 5,000 to 10,000 sheets, and high resolution of about 1200 dpi with photographic printing are required for recent color laser printers. However, conventional toner having an average particle diameter of 8 μm or greater cannot have the characteristics because of limitations on loading capacity of the toner. Thus, attempts have been made to prepare small particulate toner having an average particle diameter of 6 μm of less with durability and fixing property using pulverization in a cost-effective and simple manner to obtain the characteristics.

However, small particulate toner has problems as described below.

First, fluidity decreases as the particle size of the toner is smaller, and thus image density decreases since the amount of toner charge is not sufficient at an initial stage of printing less than 500 sheets. In addition, the amount of a colorant needs to be increased in order to obtain a desired level of image density since the thickness of the small particulate toner layer on paper is insufficient. Sometimes, the required amount of the colorant is at least twice as much as toner. However, sufficient image density cannot be obtained in spite of increased amount of the colorant since the colorant reduces the amount of toner charge.

### SUMMARY OF THE INVENTION

The present general inventive concept provides a high-speed electrophotographic toner having a long lifetime and high resolution at increased speeds and increased amount of small particulate toner charging using a toner having a combination of external additives.

According to an aspect of the present general inventive concept, is a non-magnetic one-component electrophotographic toner i provided comprising: parent toner particles including a binder resin, a colorant and a charge control agent and having an average particle diameter of about 5 to about 7 μm; and external additives applied to the surface of the parent toner particles,

wherein the external additives comprise:

a negative charge type large particulate silica having an average primary particle diameter of about 30 to about 100 nm;

a negative charge type small particulate silica having an average primary particle diameter of about 5 to about 20 nm;

a conductive titanium oxide;

strontium titanate; and

an aluminum oxide.

The amount of the large particulate silica may be in the range of about 0.1 to about 3.5 parts by weight based on 100 parts by weight of the parent toner particles.

The amount of the small particulate silica may be in the range of about 0.1 to about 2.0 parts by weight based on 100 parts by weight of the parent toner particles

The amount of the conductive titanium oxide may be in the range of about 0.1 to about 2.0 parts by weight based on 100 parts by weight of the parent toner particles

The amount of the strontium titanate may be in the range of about 0.1 to about 1.0 parts by weight based on 100 parts by weight of the parent toner particles.

The amount of the aluminum oxide may be in the range of about 0.1 to about 1.0 parts by weight based on 100 parts by weight of the parent toner particles.

Electrophotographic toner according to the present general inventive concept has excellent initial charge characteristics and a stable amount of toner charge by adding external additives including two types of negative charge type silica having different particle sizes, a conductive titanium oxide, strontium titanate and an aluminum oxide to form a small particulate toner. Thus, the electrophotographic toner is suitable for a high-speed high-quality imaging printer.

These and other aspects of the invention will become apparent from the following detailed description of the invention which disclose various embodiments of the invention.

### BRIEF DESCRIPTION OF THE DRAWINGS

The above and other features and advantages of the present general inventive concept will become more apparent by describing in detail exemplary embodiments thereof with reference to the attached drawing in which:

FIG. 1 schematically shows an electrophotographic apparatus employing a non-contact non-magnetic one-component toner.

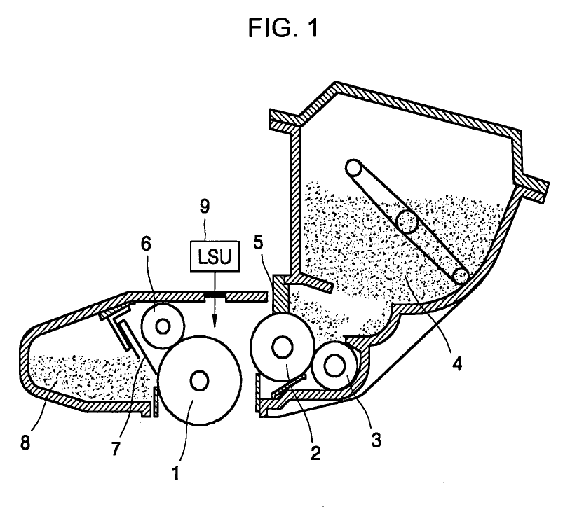

### DETAILED DESCRIPTION OF THE INVENTION

Hereinafter, the present general inventive concept will now be described more fully with reference to the accompanying drawing, in which exemplary embodiments of the invention are shown.

An electrophotographic toner according to the present general inventive concept includes: parent toner particles having a binder resin, a colorant and a charge control agent and having an average particle diameter of about 5 to about 7 μm; and external additives applied to the surface of the parent toner particles, wherein the external additives include: a negative charge type large particulate silica having an average primary particle diameter of about 30 to about 100 nm; a negative charge type small particulate silica having an average primary particle diameter of about 5 to about 20 μm; a conductive titanium oxide; strontium titanate; and an aluminum oxide.

The small particulate silica and large particulate silica are added as an external additive to the electrophotographic toner according to the present general inventive concept to provide a negative charge property and fluidity to the toner. They can be prepared from a halogenated silicon, etc. by a dry method or extracted from silicon in a liquid by a wet method as known in the art.

The large particulate silica having an average primary particle diameter of about 30 to about 100 nm increases the separation between the parent toner particles. The small particulate silica having an average primary particle diameter of about 5 to about 20 nm provides fluidity for the toner.

The amount of the large particulate silica may be in the range of about 0.1 to about 3.5 parts by weight based on 100 parts by weight of the parent toner particles. When the amount of the large particulate silica is less than 0.1 parts by weight, the effect of the large particulate silica is negligible and does not provide the desired separation of toner particles. On the other hand, when the amount is greater than 3.5 parts by weight, the fixing property may decrease, the toner may be overcharged or contaminated, or filming may occur.

The amount of the small particulate silica may be in the range of about 0.1 to about 2.0 parts by weight based on 100 parts by weight of the parent toner particles. When the amount of the small particulate silica is less than 0.1 parts by weight, the effect of the small particulate silica is negligible and does not provide the desired fluidity to the toner. On the other hand, when the amount is greater than 2.0 parts by weight, the fixing properties may decrease, the toner may be overcharged or cleaning may not be properly performed.

The conductive titanium oxide used herein increases the amount of a toner charge and has excellent environmental characteristics. Although conventional nonconductive titanium oxides reduce the sensitivity of the amount of toner charge according to environmental changes, they reduce the entire amount of toner charge. However, the conductive titanium oxide has excellent environmental characteristics and increases the amount of toner charge due to its low reduction in the amount of toner charge. In particular, the conductive titanium oxide may solve toner charging problems under low temperature and low humidity conditions, and toner charge reduction problems under high temperature and high humidity conditions. In addition, the conductive titanium oxide can improve fluidity of the toner and maintain high transfer efficiency even after printing a large number of pages for a long period of time. The conductive titanium oxide has an average primary particle diameter of about 10 to about 200 nm. The amount of the conductive titanium oxide may be in the range of about 0.1 to about 2.0 parts by weight based on 100 parts by weight of the parent toner particle. When the amount of the conductive titanium oxide is less than 0.1 parts by weight, the effect of the conductive titanium oxide on charge maintaining properties with respect to environment is negligible. On the other hand, when the amount of the conductive titanium oxide is greater than 2.0 parts by weight, an image may be contaminated and the amount of toner charge may be decreased. The conductive titanium oxide can be prepared by methods known in the art.

The strontium titanate used herein increases the initial charging rate. The strontium titanate may have an average primary particle diameter of about 10 to about 200 nm. When the average primary particle diameter is less than 10 nm, the effect of the strontium titanate is negligible. On the other hand, when the average primary particle diameter is greater than 200 nm, the strontium titanate is easily separated from the toner. The amount of the strontium titanate may be in the range of about 0.1 to about 1.0 parts by weight based on 100 parts by weight of the parent toner particles. When the amount of the strontium titanate is less than 0.1 parts by weight, the effect of the strontium titanate is negligible. On the other hand, when the amount is greater than 1.0 parts by weight, the strontium titanate is easily desorbed and separated from the toner and condensation of the strontium titanate may easily occur.

The aluminum oxide used herein maintains charging properties for long-term use. The aluminum oxide has an average primary particle diameter of about 50 to about 300 nm, and preferably about 100 to about 250 nm. When the average primary particle diameter is less than 50 nm, the effect of the aluminum is negligible. On the other hand, when the average primary particle diameter is greater than 300 nm, the aluminum oxide is easily desorbed and separated from the toner. The amount of the aluminum oxide may be in the range of about 0.1 to about 1.0 parts by weight based on 100 parts by weight of the parent toner particles. When the amount of the aluminum oxide is less than 0.1 parts by weight, the effect of the aluminum is negligible. On the other hand, when the amount is greater than 1.0 parts by weight, the aluminum oxide is easily desorbed and separated from the toner and condensation of the aluminum oxide may easily occur.

The parent toner particles of the present invention include a binder resin, a colorant and a charge control agent.

The binder resin may be various resins known in the art, for example, styrene-based copolymers such as polystyrene, poly-p-chlorostyrene, poly-α-methylstyrene, styrene-chlorostyrene copolymer, styrene-propylene copolymer, styrene-vinyltoluene copolymer, styrene-vinyl naphthalene copolymer, styrene-methyl acrylate copolymer, styrene-ethyl acrylate copolymer, styrene-propyl acrylate copolymer, styrene-butyl acrylate copolymer, styrene-octyl acrylate copolymer, styrene-methyl methacrylate copolymer, styrene-ethyl methacrylate copolymer, styrene-propyl methacrylate copolymer, styrene-butyl methacrylate copolymer, styrene-a-methyl chloromethacrylate copolymer, styrene-acrylonitrile copolymer, styrene-vinyl methyl ether copolymer, styrene-vinyl ethyl ether copolymer, styrene-vinyl ethyl ketone copolymer, styrene-butadiene copolymer, styrene-acrylonitrile-indene copolymer, and styrene-maleic acid copolymer, styrene-maleic ester copolymer; polymethyl methacrylate, polyethyl methacrylate, polybutyl methacrylate, and copolymers thereof; polyvinyl chloride, polyvinyl acetate, polyethylene, polyepropylene, polyester, polyurethane, polyamide, epoxy resin, polyvinyl butyral resin, rosin, modified rosin, terpene resin, phenol resin, aliphatic or alicyclic hydrocarbon resin, aromatic petroleum resin, chlorinated paraffin, paraffin wax, etc. These resins may be used alone or in combination. Polyester-based resins are suitable for a color developing agent due to having good fixing properties and being clear.

The colorant may be carbon black or aniline black for a black toner. A non-magnetic toner according to the present general inventive concept is suitable for a color toner. Carbon black is generally used as a black colorant. To make colors, yellow colorant, magenta colorant, and cyan colorant may further be included.

For the yellow colorant, a condensation nitrogen compound, an isoindolinone compound, an anthraquinone compound, an azo metal complex, or an allyl imide compound can be used. For example, C.I. pigment yellow 12, 13, 14, 17, 62, 74, 83, 93, 94, 95, 109, 110, 111, 128, 129, 147, 168, and the like can be used.

For the magenta colorant, a condensation nitrogen compound, an anthraquinone compound, a quinacridone compound, a base dye lake compound, a naphthol compound, a benzo imidazole compound, a thioindigo compound, or a perylene compound can be used. For example, C.I. pigment red 2, 3, 5, 6, 7, 23, 48:2, 48:3, 48:4, 57:1, 81:1, 144, 146, 166, 169, 177, 184, 185, 202, 206, 220, 221, 254, and the like can be used.

For the cyan pigment, a copper phthlaocyanine compound and derivatives thereof, an anthraquinone compound, or a base dye lake compound can be used. For example, C.I. pigment blue 1, 7, 15, 15:1, 15:2, 15:3, 15:4, 60, 62, 66, and the like can be used.

Such colorants can be used alone or in a combination of two or more colorants, and are selected in consideration of color, chromacity, luminance, resistance to weather, dispersion property in toner, etc.

The charge control agent used herein which is a negative charge type charge control agent may be an organic metal complex or a chelate compound such as azo dyes containing a chromium or mono azo metal complex; a salicylic acid compound containing a metal such as chromium, iron and zinc; and an organic metal complex of an aromatic hydroxycarboxylic acid and an aromatic dicarboxylic acid, and any known charge control agent may be used without limitation. In addition, a positive charge type charge control agent may be a modified product such as nigrosine and a fatty acid metal salt thereof and an onium salt including a quaternary ammonium salt such as tributylammonium 1-hydroxy-4-naphthosulfonate and tetrabutylammonium tetrafluoro borate. These charge control agents may be used alone or in combination of at least two. Since the charge control agent stably supports toner on a developing roller by electrostatic force, stable charging may be performed and quickly using the charge control agent.

Meanwhile, the toner particles according to the present general inventive concept may further include a release agent, a long chain fatty acid or a metal salt thereof. Examples of the release agent include polyalkylene wax such as low molecular weight polypropylene and low molecular weight polyethylene, ester wax, carnauba wax, paraffin wax, long chain fatty acid, and fatty acid amide. The long chain fatty acid and the metal salt thereof may be appropriately used to protect a photoreceptor and prevent deterioration of developing, thereby obtaining a high quality image.

In order to uniformly disperse the colorant in the resin, a fusing or a master batch in which the colorant is melt-mixed with the resin at a high concentration may be used. For example, the binder resin and the colorant as essential elements may be mixed by a mixing means such as 2 rolls, 3 rolls, dispersion kneader, and a twin screw extruder. Here, the colorant may be uniformly dispersed at a temperature in the range of about 80 to about 180° C. for 10 minutes to 2 hours. Then, the dispersion is pulverized using a pulverizer such as a jet mill, a friction mill, and a circular mill, and such parent toner particles having an average particle diameter of about 5 to about 7 μm are prepared. Fluidity and charge stability may be improved by applying the external additives according to the invention.

The toner according to the present general inventive concept can be used in an electrophotographic apparatus employing a contact non-magnetic one-component developing type toner as well as an electrophotographic apparatus employing the non-contact non-magnetic one-component toner.

The invention is also directed to an electrophotographic imaging apparatus including the toner. The imaging apparatus includes a photoreceptor, a charging apparatus, a developing roller and a supply roller for supplying the toner to the photoreceptor. A further feature of the invention is to provide a method of forming an image of a paper or other substrate by depositing the toner onto a surface of a photoreceptor having a latent image thereon to form a visible toner image, transferring the toner image to the paper and fusing the toner on the paper.

The present general inventive concept will be described in more detail with reference to the Examples below, but is not limited thereto.

### EXAMPLES

### Preparation of Parent Toner Particles

### Negative Charge Type Toner Obtained by Pulverization

The composition of parent toner particles is as follows in a non-magnetic one-component developing method.

| | |
|---|---|
| polyester having a weight average molecular weight | 90.5% by weight |
| of about 100,000 | |
| colorant (carbon black (Mitsubishi Chemical | 5.0% by weight |
| Corporation)) | |
| negative charge type charge control agent (Zn complex | 1.5% by weight |
| (Hodogaya Chemical Co., Ltd.)) | |
| Paraffin wax | 3.0% by weight |

The composition was uniformly pre-mixed using a Henschel type mixer. The pre-mixed composition was added to a double screw extruder, and a melt mixture at 130° C. was extruded, cooled and solidified. Then, parent toner particles for treating with external additives were prepared using a pulverization and classification device, wherein the parent toner particles had an average particle diameter of about 6 μm.

### Example 1

External additives listed below were applied to the parent toner particles prepared according to the pulverization process described above. The amount of the external additives is based on 100 parts by weight of the parent toner particles.

| | |
|---|---|
| large particulate silica (average primary particle | 2.5 parts by weight |
| diameter of about 30 to about 50 nm) | |
| small particulate silica (average primary particle | 1.0 part by weight |
| diameter of about 7 to about 16 nm) | |
| conductive titanium oxide (average primary particle | 0.2 parts by weight |
| diameter of about 40 to about 70 nm) | |
| strontium titanate (average primary particle diameter | 0.4 parts by weight |
| of about 10 to about 20 nm) | |
| aluminum oxide (average primary particle diameter | 0.3 parts by weight |
| of about 150 to about 250 nm) | |

### Example 2

External additives listed below were applied to the parent toner particles prepared according to the pulverization process described above. The amount of the external additives is based on 100 parts by weight of the parent toner particles

| | |
|---|---|
| large particulate silica (average primary particle | 1.2 parts by weight |
| diameter of about 30 to about 50 nm) | |
| small particulate silica (average primary particle | 0.8 parts by weight |
| diameter of about 7 to about 16 nm) | |
| conductive titanium oxide (average primary particle | 0.8 parts by weight |
| diameter of about 40 to about 70 nm) | |
| strontium titanate (average primary particle diameter | 0.3 parts by weight |
| of about 10 to about 20 nm) | |
| aluminum oxide (average primary particle diameter | 0.4 parts by weight |
| of about 150 to about 250 nm) | |

### Comparative Example 1

External additives listed below were applied to the parent toner particles prepared according to the pulverization process described above. The amount of the external additives is based on 100 parts by weight of the parent toner particles.

| | |
|---|---|
| large particulate silica (average primary particle | 2.5 parts by weight |
| diameter of about 30 to about 50 nm) | |
| small particulate silica (average primary particle | 1.0 part by weight |
| diameter of about 7 to about 16 nm) | |
| conductive titanium oxide (average primary particle | 0.8 parts by weight |
| diameter of about 40 to about 70 nm) | |

### Comparative Example 2

External additives listed below were applied to the parent toner particles prepared according to the pulverization process described above. The amount of the external additives is based on 100 parts by weight of the parent toner particles.

| | |
|---|---|
| large particulate silica (average primary particle | 1.2 parts by weight |
| diameter of about 30 to about 50 nm) | |
| small particulate silica (average primary particle | 0.8 parts by weight |
| diameter of about 7 to about 16 nm) | |
| strontium titanate (average primary particle diameter | 0.3 parts by weight |
| of about 10 to about 20 nm) | |
| aluminum oxide (average primary particle diameter | 0.4 parts by weight |
| of about 150 to about 250 nm) | |

<Image Evaluation (Based on Negative Charge Type Toner)>

Potential of surface (Vo): −700 V

Potential of latent image (VL): −100 V

Voltage applied to the developing roller:
Vp-p=1.8 KV, frequency=2.0 kHz,
Vdc=−500 V, efficiency rate=35% (square wave)

Gap of development: 150˜400 μm

Developing roller:
(1) Aluminum
   Illumination: Rz=1˜2.5 (after nickel gilding)
(2) Rubber roller (NBR-based elastic rubber roller)
   Resistance: 1×105 ˜5×106Ω
   Hardness: 50
   Toner: amount of charge (q/m)=−30 to −5 μC/g
      (on the developing roller after passing the layer regulation apparatus)
      The amount of toner per unit area=0.3 to 1.0 mg/cm²

<Result of Image Evaluation (Based on Negative Charge Type Toner)>

Images formed using toner prepared according to Examples 1 and 2 and Comparative Examples 1 and 2 were evaluated using a color LBP (35 ppm).

Image density was tested initially and while printing, and the results are shown in Tables 1 and 2 below.

TABLE 1
Image density of cyan colorant

| | Unit (sheets) | | | | | |
|---|---|---|---|---|---|---|
| | initial | 100 | 200 | 300 | 400 | 500 |
| Example 1 | Δ | Δ | ◯ | ◯ | ◯ | ◯ |
| Example 2 | ◯ | ◯ | ◯ | ◯ | ◯ | ◯ |
| Comparative Example 1 | X | X | Δ | Δ | ◯ | ◯ |
| Comparative Example 2 | Δ | Δ | Δ | ◯ | ◯ | ◯ |

TABLE 2
Image density of magenta colorant

| | Unit (sheets) | | | | | |
|---|---|---|---|---|---|---|
| | initial | 2,000 | 4,000 | 6,000 | 8,000 | 10,000 |
| Example 1 | Δ | ◯ | ◯ | ◯ | ◯ | Δ |
| Example 2 | ◯ | ◯ | ◯ | ◯ | ◯ | ∘ |
| Comparative Example 1 | X | Δ | ◯ | ◯ | ◯ | Δ |
| Comparative Example 2 | X | Δ | Δ | Δ | X | X |

As shown in Tables 1 and 2, the image density of cyan colorant was evaluated from initial to 500 sheets, based on the image density when 1,000 sheets were printed. The image density of magenta colorant was evaluated based on 1.1 of Magbeth densitometer.

In Table 1, “◯” indicates higher than the standard image density, “Δ” indicates 80 to 100% of the standard image density, and “X” indicates less than 80% of the standard image density.

In Table 2, “◯” indicates higher than the standard image density, “Δ” indicates 80 to 100% of the standard image density, and “X” indicates less than 80% of the standard image density.

As shown in Tables 1 and 2, the toner according to the present general inventive concept can maintain image density initially as well as after long-term use, thereby consistently forming high-quality images over a long period of use.

In the electrophotographic non-magnetic one-component toner according to the present general inventive concept, high-quality and high-speed imaging can be performed by stably maintaining the amount of toner charge for initial and long-term use.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A non-magnetic one-component electrophotographic toner comprising: parent toner particles including a binder resin, a colorant and a charge control agent and having an average particle diameter of about 5 to about 7 μm; and external additives applied to the surface of the parent toner particles,
wherein the external additives comprise:
a negative charge type large particulate silica having an average primary particle diameter of about 30 to about 100 nm;
a negative charge type small particulate silica having an average primary particle diameter of about 5 to about 20 nm;
a conductive titanium oxide;
strontium titanate; and
an aluminum oxide.

2. The non-magnetic one-component electrophotographic toner of claim 1, wherein the amount of the large particulate silica is in the range of about 0.1 to about 3.5 parts by weight based on 100 parts by weight of the parent toner particles.

3. The non-magnetic one-component electrophotographic toner of claim 1, wherein the amount of the small particulate silica is in the range of about 0.1 to about 2.0 parts by weight based on 100 parts by weight of the parent toner particles.

4. The non-magnetic one-component electrophotographic toner of claim 1, wherein the amount of the conductive titanium oxide is in the range of about 0.1 to about 2.0 parts by weight based on 100 parts by weight of the parent toner particles.

5. The non-magnetic one-component electrophotographic toner of claim 1, wherein the amount of the strontium titanate is in the range of about 0.1 to about 1.0 parts by weight based on 100 parts by weight of the parent toner particles.

6. The non-magnetic one-component electrophotographic toner of claim 1, wherein the amount of the aluminum oxide is in the range of about 0.1 to about 1.0 parts by weight based on 100 parts by weight of the parent toner particles.

7. The non-magnetic one-component electrophotographic toner of claim 1, wherein the strontium titanate has an average primary particle diameter of about 10 to about 200 nm.

8. The non-magnetic one-component electrophotographic toner of claim 1, wherein the aluminum oxide has an average primary particle diameter of about 50 to about 300 nm.

9. The non-magnetic one-component electrophotographic toner of claim 1, wherein the conductive titanium oxide has an average primary particle diameter of about 10 to about 200 nm.

10. The non-magnetic one-component electrophotographic toner of claim 1, wherein the aluminum oxide has an average primary particle diameter of about 100 to about 250 nm.

11. An electrophotographic imaging apparatus including the electrophotographic one-component toner of claim 1.

12. A method of forming an image comprising depositing a toner according to claim 1 on a surface of a photoreceptor having a latent image thereon to form a toner image, transferring the toner image to a substrate and fusing the toner to the substrate.
